(19) United States
(12) Patent Application Publication
(10) Pub. No.: US 2026/0072371 A1
(43) Pub. Date: Mar. 12, 2026

(54) IMAGE FORMING SYSTEM AND NON-TRANSITORY COMPUTER READABLE MEDIUM

(71) Applicant: FUJIFILM Business Innovation Corp., Tokyo (JP)

(72) Inventor: Kazunari YAMAGISHI, Kanagawa (JP)

(73) Assignee: FUJIFILM Business Innovation Corp., Tokyo (JP)

(21) Appl. No.: 19/059,806

(22) Filed: Feb. 21, 2025

(30) Foreign Application Priority Data
Sep. 6, 2024 (JP) 2024-154154

(51) Int. Cl. G03G 15/02; G03G 15/00

(52) U.S. Cl. CPC G03G 15/0266; G03G 15/5045; G03G 15/751

(57) ABSTRACT

PROBLEM TO BE SOLVED: To provide an image forming apparatus that can effectively reduce the occurrence of image failure and generation of a discharge product by correcting a charge voltage according to a change in electrical characteristic of a photosensitive layer on a surface of an image carrier.

SOLUTION: An image forming apparatus comprises: an image carrier on a surface of which a photosensitive layer is formed; a charging device that charges the surface of the image carrier; a voltage application device; a temperature and humidity detection device; a time measuring unit; and a control unit. The voltage application device applies a charge voltage to the charging device. The temperature and humidity detection device detects the temperature and humidity around the image carrier. The time measuring unit measures a low-humidity environment standing time during which the image carrier is continuously in a non-driving state while the humidity detected by the temperature and humidity detection device is equal to or less than a predetermined value, and when the humidity detected by the temperature and humidity detection device exceeds the predetermined value, resets the low temperature environment standing time. The control unit sets the amount of correction of the charge voltage on the basis of the temperature and humidity detected by the temperature and humidity detection device, and changes the amount of correction of the charging voltage on the basis of the low-humidity environment standing time.

### CROSS-REFERENCE TO RELATED APPLICATIONS

This application is based on and claims priority under 35 USC 119 from Japanese Patent Application No. 2024-154154 filed Sep. 6, 2024.

### BACKGROUND

### (i) Technical Field

The present disclosure relates to an image forming system and a non-transitory computer readable medium.

### (ii) Related Art

Japanese Unexamined Patent Application Publication No. 2010-145463 discloses an image forming apparatus that supports both long-term use and short-term use of a photoreceptor drum to appropriately control, in image formation, a potential on a surface of the photoreceptor drum.

Japanese Unexamined Patent Application Publication No. 07-140735 discloses an electrophotographic method with which a residual potential generated in a photoreceptor including carbon or a thin film containing carbon as a main component as a surface protection layer and accumulation of the residual potential are efficiently reduced, a decrease in charging potential due to charging fatigue and a decrease in image quality are less likely to occur, and it is possible to maintain stable electrophotographic characteristics.

### SUMMARY

In an image forming system based on an electrophotographic style, it is impossible to print an accurate image unless a charging voltage for a photoreceptor is set to a specified voltage. The photoreceptor is electrically charged as a voltage is applied to a charging member disposed near the photoreceptor.

However, the photoreceptor fluctuates in sensitivity to the charging member depending on, for example, a use situation such as a cumulative use time. As a result, even when a voltage is applied to the charging member, it is impossible to electrically charge the photoreceptor to a predetermined voltage.

Aspects of non-limiting embodiments of the present disclosure relate to provision of an image forming system and a program that make it possible to set a charging voltage for a photoreceptor to a specified voltage regardless of a use situation of the photoreceptor.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an image forming system including: a photoreceptor formed with a film including a photosensitive layer on a surface of a base material; a charging member configured to electrically charge a surface of the photoreceptor as a voltage is applied; an exposure device configured to allow the surface of the photoreceptor to be exposed with light to form an electrostatic latent image; a developing device configured to develop the electrostatic latent image formed on the surface of the photoreceptor as a toner image; and a processor configured to use both information of a layer film thickness of an outermost layer of the photoreceptor and information of a driving frequency of the photoreceptor, the information of the driving frequency being derived from driving information of the photoreceptor in a most recently set time width, to correct the voltage to be applied to the charging member.

### BRIEF DESCRIPTION OF THE DRAWINGS

Exemplary embodiments of the present disclosure will be described in detail based on the following figures, wherein:

FIG. 1 is a view illustrating a configuration of an image forming apparatus according to an exemplary embodiment of the present disclosure;

FIG. 2 is a view illustrating a configuration of an image former in the image forming apparatus described above;

FIG. 3 is a view illustrating an example of a layer structure of a photoreceptor in the image forming apparatus described above;

FIG. 4 is a view illustrating a hardware configuration of the image forming apparatus described above;

FIG. 5 is a graph illustrating a relationship between a continuous use time of an image forming unit and an amount of change in a discharge start voltage in the image forming apparatus described above;

FIG. 6 is a graph illustrating a relationship between an application voltage to a charging member and a charging voltage for the photoreceptor in the image forming apparatus described above;

FIG. 7 is a graph illustrating a relationship between a film thickness of the photoreceptor and an amount of change in a discharge start voltage;

FIG. 8 is a graph illustrating a relationship between a one-hour driving rate and a discharge start voltage in the image forming apparatus described above;

FIG. 9 is a graph illustrating a relationship between capacity absolute humidity and a correction ratio in the image forming apparatus described above; and

FIG. 10 is a graph illustrating a relationship between a driving state and a charging voltage for the photoreceptor in the image forming apparatus described above.

### DETAILED DESCRIPTION

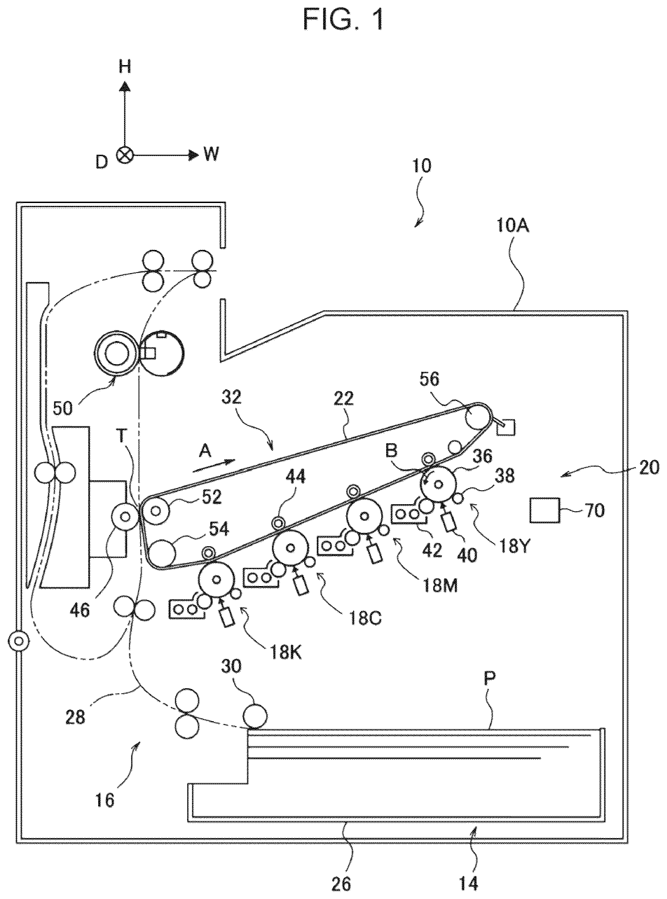

An example of an image forming apparatus 10 according to an exemplary embodiment will now be described herein with reference to FIGS. 1 to 10. In the drawings, an arrow H indicates a perpendicular direction that is also an apparatus upper-lower direction, an arrow D indicates a horizontal direction that is also an apparatus depth direction, and an arrow W indicates a horizontal direction that is also an apparatus width direction.

### [Image Forming Apparatus]

As illustrated in FIG. 1, the image forming apparatus 10 according to the exemplary embodiment includes an accommodation unit 14 storing a sheet material P serving as a recording medium, a conveyance unit 16 that conveys the sheet material P stored in the accommodation unit 14, an image former 20 that performs image formation on the sheet material P conveyed by the conveyance unit 16, and a temperature/humidity sensor 70.

The accommodation unit 14 includes an accommodation member 26 that is able to be pulled out from an apparatus main body 10A of the image forming apparatus 10 to a front side in the apparatus depth direction, and the sheet material P is stacked on the accommodation member 26. In addition, the apparatus main body 10A includes a sending roll 30 that sends out the sheet material P stacked on the accommodation member 26 to a conveyance path 28 that forms the conveyance unit 16.

The conveyance unit 16 includes a plurality of conveying rolls (their reference signs are omitted) that convey the sheet material P along the conveyance path 28 along which the sheet material P is conveyed.

The image former 20 includes four image forming units 18Y, 18M, 18C, and 18K for yellow (Y), magenta (M), cyan (C), and black (K), respectively. Note that, in those described below, when it is not necessary to distinguish Y, M, C, and K from each other for description, Y, M, C, and K may be omitted. Furthermore, it is possible to attach and detach the image forming units 18 for the respective colors to and from the apparatus main body 10A.

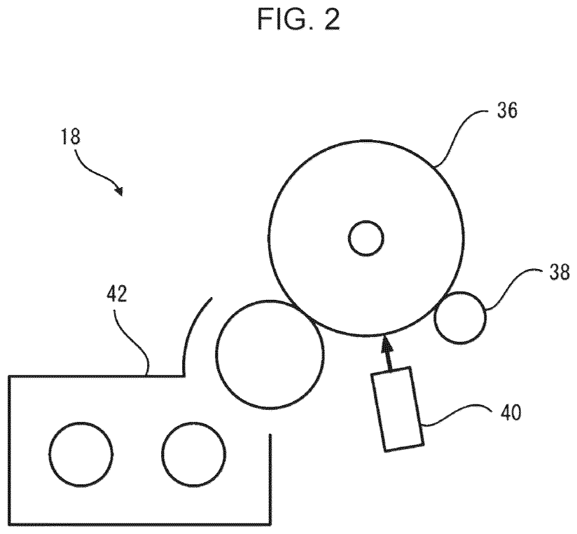

As illustrated in FIG. 2, the image forming units 18 for the respective colors each include a photoreceptor 36, a charging member 38, an exposure device 40, and a developing device 42.

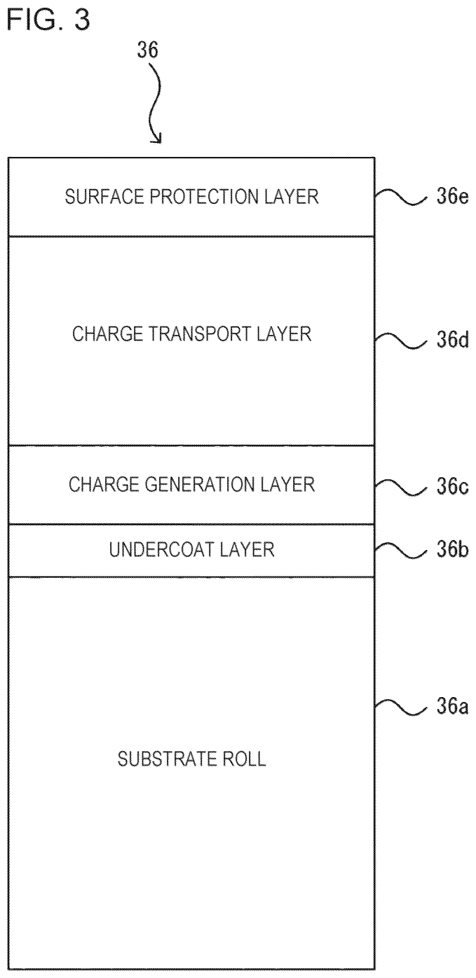

The photoreceptor 36 rotates in a direction indicated by arrow B in FIG. 1. As illustrated in FIG. 3, the photoreceptor 36 has a structure in which a surface of a substrate roll 36a is formed with, in an order from a front surface side of the substrate roll 36a, an undercoat layer 36b, a charge generation layer 36c, a charge transport layer 36d, and a surface protection layer 36e.

The charging member 38 electrically charges a surface of the photoreceptor 36 as a voltage is applied. The exposure device 40 allows the surface of the photoreceptor 36 to be irradiated with exposure light to form an electrostatic latent image. The developing device 42 develops the electrostatic latent image formed on the surface of the photoreceptor 36 into a toner image.

Furthermore, the image former 20 includes an endless belt 22 that has an endless shape and that rotates in a direction indicated by an arrow A in FIG. 1, an auxiliary roll 52 around which the endless belt 22 is wound, a tension applying roll 54, and a driving roll 56. In addition, the image former 20 includes primary transfer rolls 44 that transfers the toner image formed by each of the image forming units 18 for the respective colors onto the endless belt 22.

Furthermore, the image former 20 includes a secondary transfer roll 46 that transfers the toner image transferred onto the endless belt 22 onto the sheet material P. Then, a transfer device 32 is formed to include the endless belt 22, the auxiliary roll 52, the tension applying roll 54, the driving roll 56, and the primary transfer rolls 44. In addition, the image former 20 includes a fixing device 50 for heating and pressing the sheet material P on which the toner image is transferred to fix the toner image on the sheet material P.

The temperature/humidity sensor 70 is a sensor that detects a temperature and relative humidity in the apparatus main body 10A.

### [Control Unit]

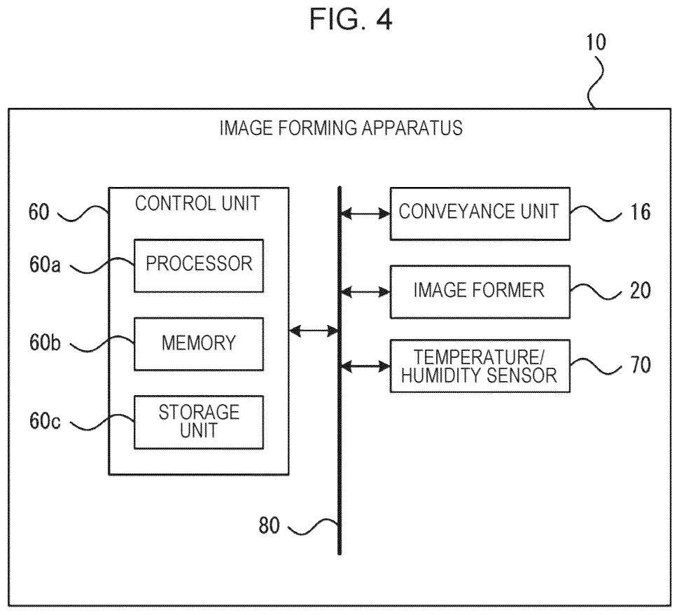

Next, the control unit 60 that controls operation of the image forming apparatus 10 will now be described herein with reference to FIG. 4. As illustrated in FIG. 4, the control unit 60 includes a processor 60a, a memory 60b, and a storage unit 60c. The processor 60a executes predetermined processing based on a program read from the storage unit 60c and developed in the memory 60b. The storage unit 60c includes, for example, a read only memory (ROM), a hard disk drive (HDD), or a solid state drive (SSD). The storage unit 60c stores various types of programs and data, for example.

Note that, although, in the present exemplary embodiment, the processor 60a reads and executes the programs stored in the storage unit 60c, the present disclosure is not limited the exemplary embodiment. The programs may be provided in a form of being recorded in a computer-readable recording medium as described above. Furthermore, the programs may be acquired from an external device via a communication line.

The control unit 60 is coupled to the conveyance unit 16, the image former 20, and the temperature/humidity sensor 70 via a control bus 80.

The control unit 60 performs various types of controls for conveying the sheet material P with respect to the conveyance unit 16. Furthermore, the control unit 60 performs various types of controls for image formation with respect to the image former 20.

### [Outline of Image Forming Step]

Next, an outline of an image forming step in the image forming apparatus 10 will now be described herein.

The control unit 60 first applies a voltage to the charging member 38 for each of the image forming units 18 for the respective colors of yellow, magenta, cyan, and black to cause the charging member 38 applied with the voltage to electrically charge the surface of the photoreceptor 36 to a predetermined potential. Next, based on image data for printing, the control unit 60 causes the exposure device 40 to cause the surface of the photoreceptor 36 electrically charged by the charging member 38 to be irradiated with light to form an electrostatic latent image. As a result, the electrostatic latent image corresponding to the image data is formed on the surface of the photoreceptor 36.

Next, the control unit 60 causes the developing device 42 to develop the electrostatic latent image formed by the exposure device 40 to visualize the electrostatic latent image as a toner image. Next, the control unit 60 causes the primary transfer rolls 44 to each sequentially transfer the toner image formed on the surface of the photoreceptor 36 for each of the colors onto the endless belt 22 that is rotating.

On the other hand, the control unit 60 cause the sending roll 30 to convey the sheet material P from the accommodation member 26 to the conveyance path 28, and to a transfer position T where the endless belt 22 and the secondary transfer roll 46 are in contact with each other. Next, the control unit 60 causes, at the transfer position T, the sheet material P to be conveyed between the endless belt 22 and the secondary transfer roll 46 to allow the toner image of each of the colors on an outer circumferential surface of the endless belt 22 to be transferred onto the sheet material P.

Next, the control unit 60 causes the fixing device 50 to fix the toner image transferred onto a surface of the sheet material P to the sheet material P. Next, the control unit 60 causes the sheet material P fixed with the toner image to be discharged to outside of the apparatus main body 10A.

### [Correction Processing for Application Voltage to Charging Member 38]

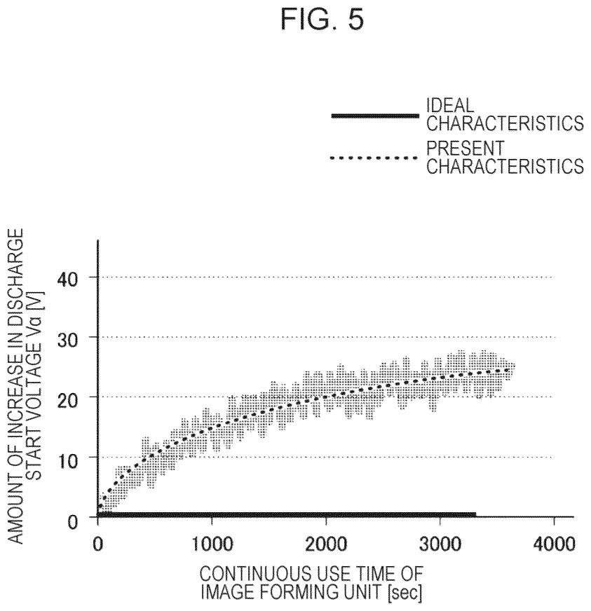

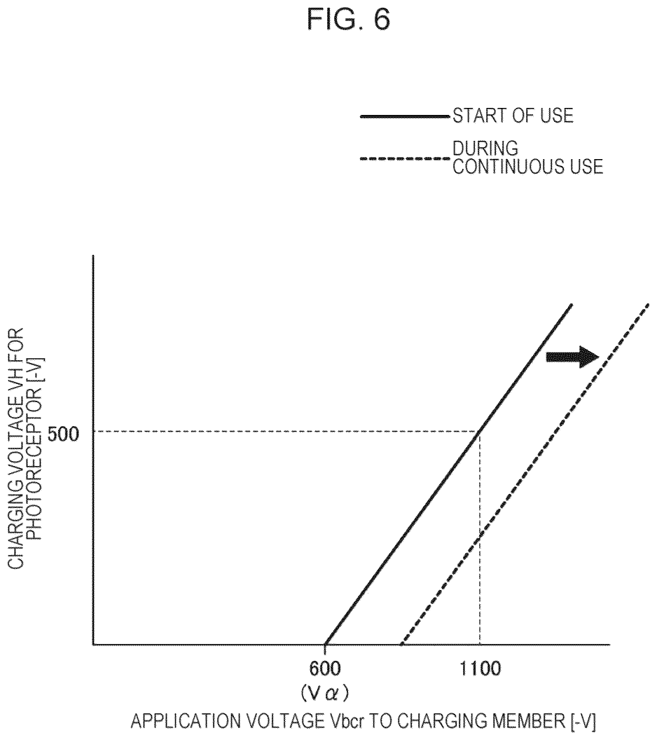

Next, correction processing for an application voltage to the charging member 38 will now be described herein. FIG. 5 is a graph illustrating a relationship between a continuous use time of the image forming unit 18 and an amount of change in a discharge start voltage Va in the image forming apparatus 10 according to the present exemplary embodiment. FIG. 6 is a graph illustrating a relationship between an application voltage Vbcr to the charging member 38 and a charging voltage VH for the photoreceptor 36 in the image forming apparatus 10 according to the present exemplary embodiment.

In the image forming apparatus 10 applied with the electrophotographic style, a charging voltage for the photoreceptor 36 represents a voltage for a bright portion during exposure of light. Therefore, it is impossible to print an accurate image unless the charging voltage for the photoreceptor 36 is set to a specified voltage. The photoreceptor 36 is electrically charged as a voltage is applied to the charging member 38 disposed near the photoreceptor 36.

However, when the image forming unit 18 is continuously used, electrons accumulated at an interface between the charge generation layer 36c and the undercoat layer 36b of the photoreceptor 36 strengthen an internal electric field, reducing an amount of movement of an electric charge within a film of the photoreceptor 36. As a result, as illustrated in FIG. 5, an absolute value of the discharge start voltage Va for the photoreceptor 36 increases.

Note herein that, the discharge start voltage Va represents a voltage at which charging of electricity for the photoreceptor 36 is started when an absolute value of the voltage to be applied to the charging member 38 is increased. In other words, the discharge start voltage Va represents a difference between the application voltage Vbcr to the charging member 38 and the charging voltage VH for the photoreceptor 36.

As illustrated in FIG. 6, when the application voltage Vbcr to the charging member 38 is constant, an increase in the absolute value of the discharge start voltage Va results in a decrease in an absolute value of the charging voltage VH for the photoreceptor 36, causing abnormal image quality since a background has an increased amount of unwanted toner due to a decrease in an absolute value of a cleaning potential (that is, a difference between the charging voltage VH and a development output). Furthermore, an amount of use of a toner increases due to the increased amount of unwanted toner of the background, shortening a life of a toner cartridge.

To solve such a problem as described above, the control unit 60 according to the present exemplary embodiment uses both information of a layer film thickness of an outermost layer of the photoreceptor 36 and information of a driving frequency of the photoreceptor 36, which is derived from driving information of the photoreceptor 36 in a most recently set time width, to correct the voltage to be applied to the charging member 38.

In the image forming apparatus 10 according to the present exemplary embodiment, the control unit 60 may perform a correction to increase an influence of the driving frequency as the layer film thickness of the outermost layer of the photoreceptor 36 becomes smaller.

Furthermore, the control unit 60 may estimate the layer film thickness of the outermost layer of the photoreceptor 36 from a cumulative use time of the photoreceptor 36.

Furthermore, the control unit 60 may use information of the temperature and the relative humidity around the photoreceptor 36 to correct the voltage to be applied to the charging member 38. In this case, the control unit 60 may derive absolute humidity around the photoreceptor 36 from the temperature and the relative humidity around the photoreceptor 36, to use information of the derived absolute humidity around the photoreceptor 36, and to correct the voltage to be applied to the charging member 38.

The correction processing for the application voltage to the charging member 38 in the image forming apparatus 10 according to the present exemplary embodiment will now be described herein in detail.

The control unit 60 according to the present exemplary embodiment performs the correction processing for the application voltage to the charging member 38 with steps 1 to 5 for the processing described below.

Step 1: A reference value for the amount of change in the discharge start voltage Va is calculated in accordance with a film thickness of the surface protection layer 36e that is the outermost layer of the photoreceptor 36.

Step 2: A correction coefficient in accordance with the driving frequency of the photoreceptor 36, which is derived from the driving information of the photoreceptor 36 in a most recently set time width, is calculated.

Step 3: A correction coefficient in accordance with the temperature and the relative humidity around the photoreceptor 36 is calculated.

Step 4: The numerical values calculated in steps 1 to 3 are multiplied to calculate an amount of correction in accordance with characteristics of the photoreceptor 36 in the most recently set time width.

Step 5: The amount of correction, which is calculated in step 4, is further corrected in accordance with long-term use data of the photoreceptor 36.

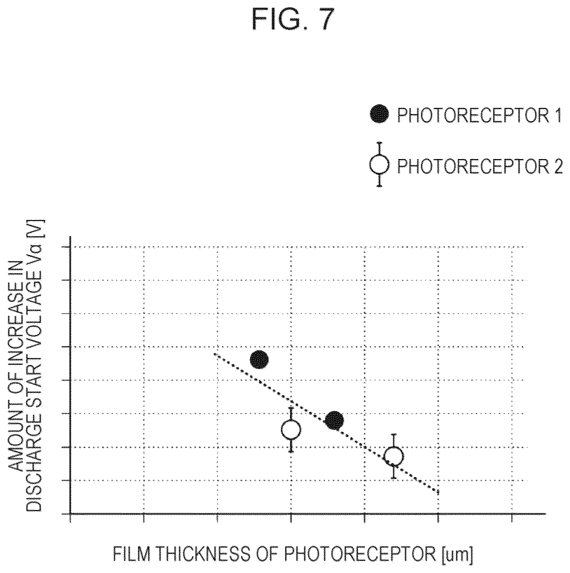

Step 1 will now first be described. In step 1, an amount of change in the discharge start voltage Va is calculated in accordance with the film thickness of the surface protection layer 36e that is the outermost layer of the photoreceptor 36. FIG. 7 is a graph illustrating a relationship between a film thickness of the photoreceptor 36 and an amount of change in the discharge start voltage Va for the photoreceptor 36.

Since, as the surface protection layer 36e that is the outermost layer of the photoreceptor 36 wears due to friction with a blade, discharge stress, and rubbing with a developer, for example, a distance between and electrostatic capacity between the charge generation layer 36c and a surface of the surface protection layer 36e changes, for a long period of time, the absolute value of the discharge start voltage Va decreases, and charging of electricity becomes easy.

On the other hand, when the image forming unit 18 is continuously used, the absolute value of the discharge start voltage Va for the photoreceptor 36 increases, as illustrated in FIG. 5 described above. An amount of change in the discharge start voltage Va at this time is set as a reference value r for a difference in correction for the application voltage to the charging member 38. It is possible to represent the reference value r by using a linear function where a film thickness ft of the photoreceptor 36 serves as a variable, as illustrated in FIG. 7 and a mathematical expression (1) described below. Note that, in the mathematical expression (1), A and B represent constants determined based on characteristics of a film.

$$r = A \times ft + B \qquad ( 1 )$$

Use data of the image forming unit 18 is recorded in a non-illustrated storage tag included in the image forming unit 18. It is considered that the film thickness of the photoreceptor 36 decreases in inverse proportion to a cumulative use time of the photoreceptor 36.

Therefore, the control unit 60 acquires the cumulative use time from the use data of the image forming unit 18, which is recorded in the storage tag, to estimate the film thickness from the acquired cumulative use time. Next, the control unit 60 substitutes the estimated film thickness into the mathematical expression (1) to acquire a reference value for the amount of change in the discharge start voltage Va.

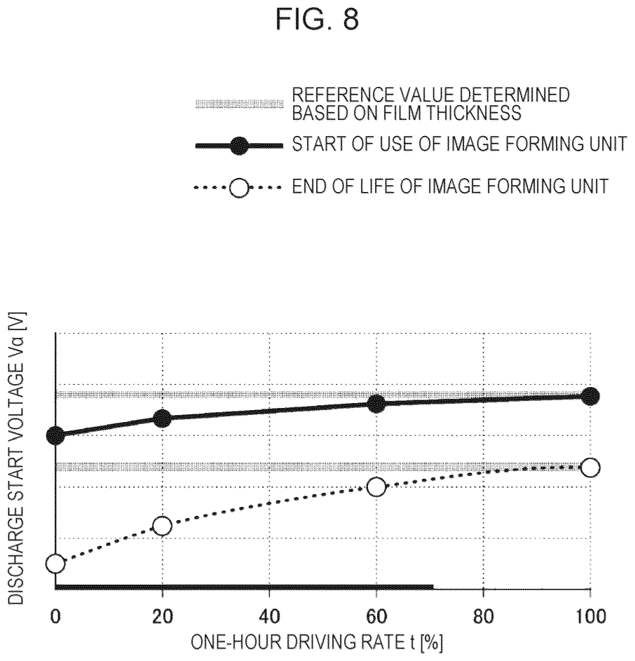

Next, step 2 will now be described. In step 2, a correction coefficient in accordance with the driving frequency of the photoreceptor 36, which is derived from the driving information of the photoreceptor 36 in the most recently set time width, is calculated. FIG. 8 is a graph illustrating a relationship between a one-hour driving rate t and the discharge start voltage Va in the image forming apparatus 10. A denominator of the one-hour driving rate t represents a number of rotations of the photoreceptor 36 when continuously driven for one hour, and a numerator represents a number of rotations of the photoreceptor 36 actually rotated for latest one hour.

As illustrated in FIG. 8, as the driving rate t of the photoreceptor 36 decreases when a most recently set time width is one hour, the absolute value of the discharge start voltage Va becomes lower than the reference value r calculated in step 1. Furthermore, as the film thickness of the surface protection layer 36e that is the outermost layer of the photoreceptor 36 decreases, an influence of the driving frequency increases. When a ratio of an amount of change from the reference value r at this time is set as a first correction coefficient c1, it is possible to express the first correction coefficient c1 as a quadratic function where the one-hour driving rate t of the photoreceptor 36 serves as a variable, as illustrated in a mathematical expression (2) described below. Note that, in the mathematical expression (2), C, D, and E represent constants determined based on characteristics of a film.

$$c 1 = - {Ct}^{2} + Dt + E \qquad ( 2 )$$

Therefore, the control unit 60 acquires the one-hour driving rate t of the photoreceptor 36 from the use data of the image forming unit 18, which is recorded in the storage tag, to substitute the acquired one-hour driving rate t into the mathematical expression (2) to acquire the first correction coefficient c1.

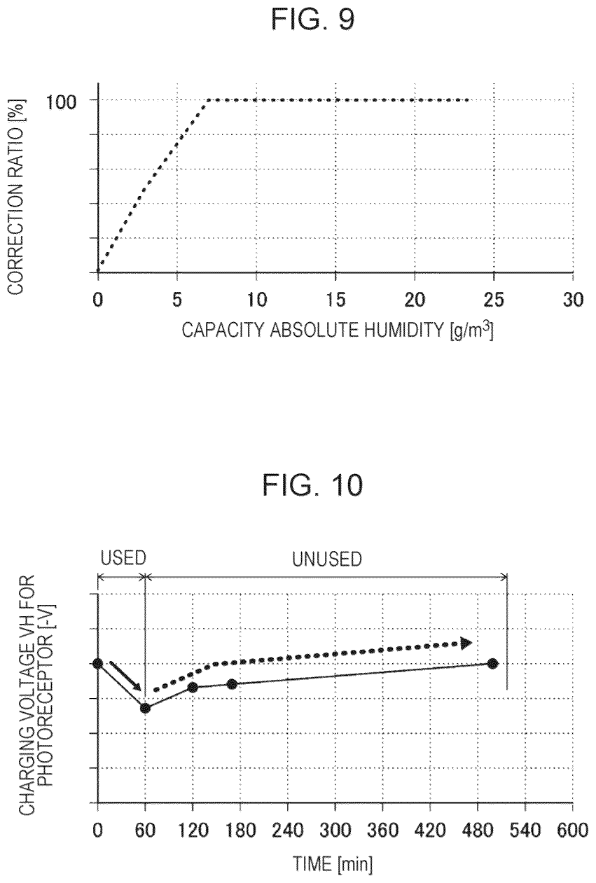

Next, step 3 will now be described. In step 3, a correction coefficient in accordance with the temperature and the relative humidity around the photoreceptor 36 is calculated. FIG. 9 is a graph illustrating a relationship between capacity absolute humidity and a correction ratio in the image forming apparatus 10.

The photoreceptor 36 is weak in a high-temperature and high-humidity environment, and presents good characteristics when used in a low-temperature and low-humidity environment. Specifically, as illustrated in FIG. 9, characteristics of the photoreceptor 36 become constant when absolute humidity is 7 or higher, and the characteristics change linearly when the absolute humidity is lower than 7.

Therefore, the control unit 60 acquires information of the temperature and the relative humidity around the photoreceptor 36 from the temperature/humidity sensor 70 to derive absolute humidity around the photoreceptor 36 from the temperature and the relative humidity around the photoreceptor 36. Next, the control unit 60 uses the derived absolute humidity to acquire a correction ratio as a second correction coefficient c2 from the characteristics illustrated in the graph in FIG. 9.

Next, step 4 will now be described. In step 4, the numerical values calculated in steps 1 to 3 are multiplied to calculate an amount of correction in accordance with the characteristics of the photoreceptor 36 in a most recently set time width.

Specifically, as illustrated in a mathematical expression (3) described below, the control unit 60 multiplies the reference value r acquired in step 1, the first correction coefficient c1 acquired in step 2, and the second correction coefficient c2 acquired in step 3 to acquire an amount of correction v.

$$v = r \times c 1 \times c 2 \qquad ( 3 )$$

Next, step 5 will now be described. In step 5, the amount of correction v calculated in step 4 is further corrected in accordance with the long-term use data of the photoreceptor 36. FIG. 10 is a graph illustrating a relationship between a driving state and the charging voltage VH for the photoreceptor 36 in the image forming apparatus 10.

As illustrated in FIG. 10, when the image forming unit 18 is continuously used, the absolute value of the charging voltage VH for the photoreceptor 36 decreases. On the other hand, when the image forming unit 18 is left unused, the charging voltage VH for the photoreceptor 36 is recovered. There is a difference between speeds at which the charging voltage VH decreases and recovers.

Therefore, the control unit 60 acquires data of a use situation from immediately after start of use to a present time from the use data of the image forming unit 18, which is recorded in the storage tag, to acquire a present value of the charging voltage VH. Next, the control unit 60 acquires a present amount of change v1 in the discharge start voltage Vα from the acquired present value of the charging voltage VH to add the amount of correction v acquired in step 4 to the present amount of change v1 in the discharge start voltage Vα to acquire a final amount of correction vf, as illustrated in a mathematical expression (4) described below.

$$vf = v 1 + v \qquad ( 4 )$$

The control unit 60 adds the amount of correction vf acquired through steps 1 to 5 in the processing to the application voltage to the charging member 38 to perform the correction processing for the application voltage to the charging member 38. As a result, it is possible to correct fluctuation in the charging voltage VH for the photoreceptor 36, which is caused by the latest driving frequency of the photoreceptor 36, which varies depending on the film thickness of the photoreceptor 36, compared with a case where a correction is performed by using either information of the film thickness of the photoreceptor 36 or information of the latest driving frequency of the photoreceptor 36. Therefore, it is possible to set the charging voltage VH for the photoreceptor 36 to a specified voltage regardless of the use situation of the photoreceptor 36.

### [Modification Examples]

Although the image forming system according to the exemplary embodiment of the present disclosure has been described above, the technique of the present disclosure is not limited to the exemplary embodiment described above and can be appropriately modified.

In the exemplary embodiment described above, the processor refers to a processor in a broad sense, and includes general-purpose processors (for example, central processing units (CPUs)) and dedicated processors (for example, graphics processing units (GPUs), application specific integrated circuits (ASICs), field programmable gate arrays (FPGAs), and programmable logic devices).

Furthermore, operations of the processor in the exemplary embodiment described above may be not only operations performed by one processor, but also operations performed, in cooperation with each other, by a plurality of processors that exist at physically distant positions. Furthermore, the order of the operations of the processor is not limited to the order described in the exemplary embodiment described above, and may be appropriately modified.

Furthermore, in the technique of the present disclosure, a system includes both one configured by a plurality of devices or apparatuses and one configured by a single device or apparatus.

Furthermore, it is also possible to apply the technique of the present disclosure to a program and a program product.

### APPENDIX

(((1)))

An image forming system comprising:
a photoreceptor formed with a film including a photosensitive layer on a surface of a base material;
a charging member configured to electrically charge a surface of the photoreceptor as a voltage is applied;
an exposure device configured to allow the surface of the photoreceptor to be exposed with light to form an electrostatic latent image;
a developing device configured to develop the electrostatic latent image formed on the surface of the photoreceptor as a toner image; and
a processor configured to use both information of a layer film thickness of an outermost layer of the photoreceptor and information of a driving frequency of the photoreceptor, the information of the driving frequency being derived from driving information of the photoreceptor in a most recently set time width, to correct the voltage to be applied to the charging member.
   (((2)))

The image forming system according to (((1))), wherein the processor is configured to perform a correction to increase an influence of the driving frequency as the layer film thickness of the outermost layer of the photoreceptor becomes smaller.

(((3)))

The image forming system according to (((1))) or (((2))), wherein the processor is configured to estimate the layer film thickness of the outermost layer of the photoreceptor from a cumulative use time of the photoreceptor.

(((4)))

The image forming system according to any one of (((1))) to (((3))), further comprising:
a temperature sensor configured to measure a temperature around the photoreceptor; and
a relative humidity sensor configured to measure relative humidity around the photoreceptor,
wherein the processor is configured to use information of the temperature and the relative humidity around the photoreceptor to correct the voltage to be applied to the charging member.
   (((5)))

The image forming system according to (((4))), wherein the processor is configured to:
derive absolute humidity around the photoreceptor from the temperature and the relative humidity around the photoreceptor; and
use information of the derived absolute humidity around the photoreceptor to correct the voltage to be applied to the charging member.
   (((6)))

A program causing a computer to execute a process for controlling an image forming system including:
a photoreceptor formed with a film including a photosensitive layer on a surface of a base material;
a charging member configured to electrically charge a surface of the photoreceptor as a voltage is applied;
an exposure device configured to allow the surface of the photoreceptor to be exposed with light to form an electrostatic latent image; and
a developing device configured to develop the electrostatic latent image formed on the surface of the photoreceptor as a toner image,
the process comprising:
using both information of a layer film thickness of an outermost layer of the photoreceptor and information of a driving frequency of the photoreceptor, the information of the driving frequency being derived from driving information of the photoreceptor in a most recently set time width, to correct the voltage to be applied to the charging member.

What is claimed is:

1. An image forming system comprising:
a photoreceptor formed with a film including a photosensitive layer on a surface of a base material;
a charging member configured to electrically charge a surface of the photoreceptor as a voltage is applied;
an exposure device configured to allow the surface of the photoreceptor to be exposed with light to form an electrostatic latent image;
a developing device configured to develop the electrostatic latent image formed on the surface of the photoreceptor as a toner image; and
a processor configured to use both information of a layer film thickness of an outermost layer of the photoreceptor and information of a driving frequency of the photoreceptor, the information of the driving frequency being derived from driving information of the photoreceptor in a most recently set time width, to correct the voltage to be applied to the charging member.

2. The image forming system according to claim 1, wherein the processor is configured to perform a correction to increase an influence of the driving frequency as the layer film thickness of the outermost layer of the photoreceptor becomes smaller.

3. The image forming system according to claim 2, wherein the processor is configured to estimate the layer film thickness of the outermost layer of the photoreceptor from a cumulative use time of the photoreceptor.

4. The image forming system according to claim 1, further comprising:
a temperature sensor configured to measure a temperature around the photoreceptor; and
a relative humidity sensor configured to measure relative humidity around the photoreceptor,
wherein the processor is configured to use information of the temperature and the relative humidity around the photoreceptor to correct the voltage to be applied to the charging member.

5. The image forming system according to claim 4, wherein the processor is configured to:
derive absolute humidity around the photoreceptor from the temperature and the relative humidity around the photoreceptor; and
use information of the derived absolute humidity around the photoreceptor to correct the voltage to be applied to the charging member.

6. A non-transitory computer readable storage medium storing a program causing a computer to execute a process for controlling an image forming system including:
a photoreceptor formed with a film including a photosensitive layer on a surface of a base material;
a charging member configured to electrically charge a surface of the photoreceptor as a voltage is applied;
an exposure device configured to allow the surface of the photoreceptor to be exposed with light to form an electrostatic latent image; and
a developing device configured to develop the electrostatic latent image formed on the surface of the photoreceptor as a toner image,
the process comprising:
using both information of a layer film thickness of an outermost layer of the photoreceptor and information of a driving frequency of the photoreceptor, the information of the driving frequency being derived from driving information of the photoreceptor in a most recently set time width, to correct the voltage to be applied to the charging member.
